(19) United States
(12) Patent Application Publication
(10) Pub. No.: US 2014/0299812 A1
(43) Pub. Date: Oct. 9, 2014

(54) ENERGY SAVING FLUID

(71) Applicant: ISTANBUL KURUMSAL PAZARLAMA DANISMANLIK KIMYA SANAYI VE TICARET ANONIM SIRKETI, Istanbul (TR)

(72) Inventor: Umit Ozdoruk, Istanbul (TR)

(73) Assignee: ISTANBUL KURUMSAL PAZARLAMA DANISMANLIK KIMYA SANAYI VE TICARET ANONIM SIRKETI, Istanbul (TR)

(21) Appl. No.: 14/357,197

(22) PCT Filed: Oct. 30, 2012
(86) PCT No.: PCT/IB2012/056018

§ 371 Date: May 8, 2014

(51) Int. Cl. C09K 5/10

(52) U.S. Cl. CPC C09K 5/10
USPC 252/75

(57) ABSTRACT

This invention relates to an energy saving fluid composition used in both cooling and heating heat transfer systems. The energy saving fluid composition reduces the energy consumption and increases the heat transfer performance in heat transfer systems operated with water.

### FIELD OF THE INVENTION

The present invention relates to a new and improved water-glycol based energy transmitting fluid for saving energy used in closed circuit systems operating with water

### PRIOR ART

With the increase of energy costs, system efficiency becomes vital. Heat transfer fluids serve an important role in the efficient use of energy and new systems or compositions are designed to avoid the decrease of efficiency. These precautions are aimed to prevent the effects of corrosion, calcification, algae formation and freezing.

In industrial applications, wherever water cannot be used petroleum based fluids are used in heat transfer systems in high temperatures despite their risks.

The most commonly used water-glycol based fluids involve ethylene glycol (EG) and propylene glycol (PG). Ethylene glycol and its antidote propylene glycol are used as antifreeze fluids by means of their suitable features such as having low freezing point, compared to water. These water based fluids also provide freeze protection and burst protection. It is also known that ethylene glycol (C2H602) is a better heat transfer fluid than propylene glycol (C3H8O2) by means of its low viscosity feature.

On the other hand, propylene glycol is less toxic and is considered in applications where toxicity is a concern. At low temperatures, propylene glycol itself is highly viscous.

In addition to these features above, to lower the operational system cost and optimize the energy efficiency of such heat transfer fluids, increasing the heat absorption of the heat exchange liquid while decreasing the heat loss is one of the critical points. Specific heat, thermal conductivity, density, viscosity, flow rate and pumpability are also important factors because they affect the economics of the operation. For instance, if the viscosity is too high, then a large amount of electricity should be consumed to pump the fluid through the system. In addition, in these systems the heat is not distributed homogeneously. When only ethylene glycol or propylene glycol are used in these fluids, because of their corrosive effects pitting and wearout occur in time.

The European patent document numbered EP1857520 discloses a composition with high heat-storage property. To prevent the heat loss, the composition is formed by a crosslink reaction between hydroxyl groups such as ethylene glycol or propylene glycol and carboxyl groups such as triethanolamine.

The European patent document numbered EP0055488 discloses water-based energy transmitting fluid composition. The main concept of the composition consists of nitroaromatic compounds and hydroxyl aromatic acids and the invention enhance lubricity and anti-wear properties of composition. The composition also contains more water than the 50 percent to which such known fluids are generally limited in commercial applications. The composition involves TEA for its corrosion inhibitor effect and EG (or PG) for its antifreeze effect.

The International patent document numbered WO0196493 discloses a non-hazardous, reduced toxicity ethylene glycol based heat transfer fluid. The fluid consists of ethylene glycol and an antidote for ethylene glycol poisoning that has a boiling point above about 150° C. In this invention, it is found that addition of propylene glycol or glycerol to ethylene glycol based antifreeze unexpectedly decreases the toxicity more than it would be predicted based upon the toxicity of the components by themselves.

However, water-glycol type heat transfer fluids, such as above-cited patents, generally have relatively high energy consumption properties in closed circuit operating systems applications. None of the aforementioned prior art patents disclose a chemical composition having an improved and distinct feature for reducing the energy consumption and increasing the heat transfer performance in closed circuit operating systems applications.

The efficiency of heating/cooling system is related to the energy consumption efficiency and heat transfer efficiency. Within the system, it is hard to transfer the total heat energy gained from the heater/cooler to system's pipes without any loss. In these systems, water is preferably used. However, the heat transfer efficiency of water is very low and also systems using water deal with vaporization and expansion problems.

The disclosures of the prior art regarding the listed benefits above of additive containing fluids notwithstanding, prior to this invention such characteristics of water-glycol type fluids have limited the use of such fluids for minimizing the negative effect of water and for creating an optimal condition to increase the efficiency in closed circuit operating systems.

### SUMMARY OF THE INVENTION

The object of the invention is to provide an energy saving fluid composition for closed circuit operating systems applications.

Further object of the invention is to provide an energy saving fluid composition that reduces the energy consumption in heat transfer systems operated with water.

Another object of the invention is to provide an energy saving fluid composition that improves the heat transfer performance and reduces the energy consumption by increasing the efficiency of the system.

### DETAILED DESCRIPTION OF THE INVENTION

“An Energy Saving Fluid” realized to fulfill the objective of the present invention is illustrated in the accompanying figures, in which,

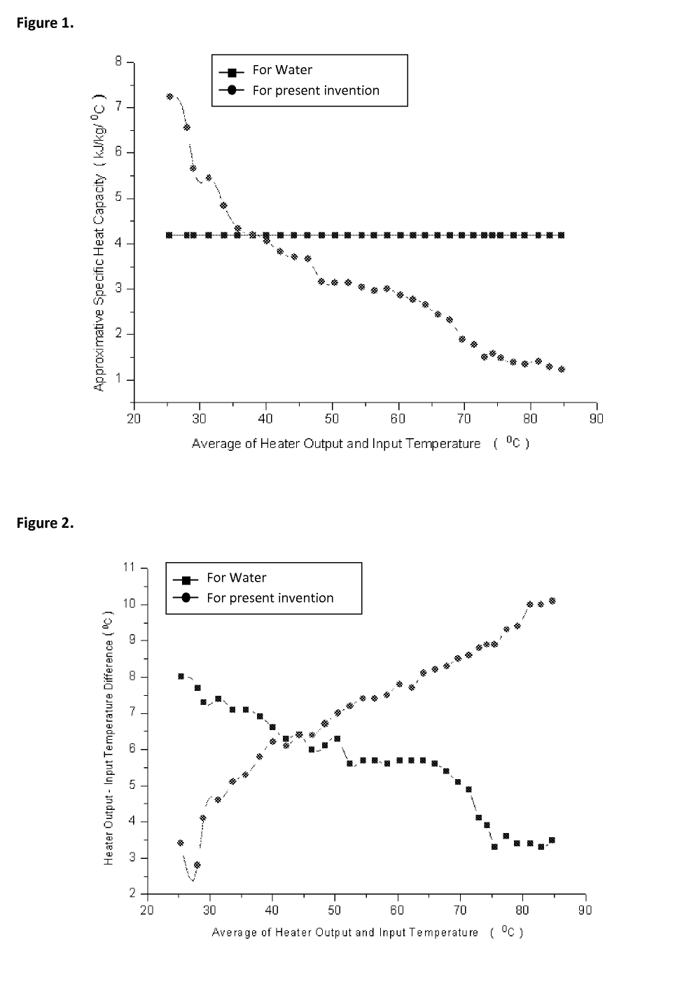

FIG. 1 is the graph showing the change of specific heat capacity with temperature for the present invention and water.

FIG. 2 is the graph showing the temperature difference between input and output with temperature for the present invention and water.

An energy saving fluid consisting essentially of;
monoethylene glycol (MEG) in the overall range of 70% to 80% by volume of the fluid composition,
glycerin in the overall range of 10% to 20% by volume of the fluid composition,
triethanolamine in the overall range of 0.01% to % 3 by volume of the fluid composition,
corrosion inhibitor in the overall range of 0.01% to % 3 by volume of the fluid composition,
a pH control agent in the overall range of 0.01% to % 4 by volume of the fluid composition,

In the preferred embodiment of the present invention, the energy saving fluid composition contains propylene glycol (PG) in the overall range of 10% to 20% by volume of of the fluid composition.

In the preferred embodiment of the present invention, the energy saving fluid composition contains 0.5% pH control agent by volume of the composition. The present invention uses a pH control agent to adjust and maintain the pH of the energy saving fluid between 7.5 and 8.5.

The energy saving fluid composition of the preferred embodiment contains 0.25% corrosion inhibitor by volume of the composition. The corrosion inhibitor is selected from the group consisting of inhibitors for iron, zinc, aluminum, copper and combinations thereof.

The fluid described in the present invention is considered ready to use an energy saving fluid and isused by dilution with water to any extent, the dilution upon the operating conditions which need to be satisfied.

In the preferred embodiment of the present invention, the energy saving fluid is diluted by water to % 40 to & 60 for the use in heat transfer systems. The diluted composition is preferably used in % 50 diluted form. The term “composition” and “energy saving fluid” are as used herein, unless otherwise defined, means as diluted energy saving fluid composition.

The energy saving fluid provides reduction in operation duration and energy consumption in heat transfer systems comparing with applications using % 100 water.

The energy saving fluid having enhanced heat transfer performance and reduced energy consumption properties which comprises an aqueous composition has a viscosity in a range of 0.015-0.025 Pa·s. The freezing point of the invention is about −40° C. and the boiling point is about 180° C. The wide temperature range gives advantages to the present invention to be used in heating and cooling systems.

The heat capacity of most fluids is not a constant. Rather, it depends on the state variables of the thermodynamic system. In particular it depends on the temperature itself, as well as on the pressure and the volume of the system, and the ways in which pressures and volumes have been allowed to change while the system has passed from one temperature to another. It is usual for the specific heat capacity of liquids to increase with increased temperature at all temperatures in heat transfer systems.

In the preferred embodiment of the invention, the specific heat capacity of the invention is slowly decreased by the increase of temperature; therefore after 40° C., the energy saving fluid provides an increase in heating rate of the system comparing with applications using % 100 water (FIG. 1). For lower temperatures than 40° C., the decrease in the specific heat capacity of the invention are not sufficient and effective to provide a better heating performance than applications using water in heating heat transfer systems. Instead, for lower temperatures than 40° C., the specific heat capacity of the invention is higher than the specific heat capacity of water and thus the invention is heated up slower than water, which is suitable for cooling heat transfer systems.

For higher temperatures than 40° C., the energy saving fluid requires less heat energy to heat up; therefore energy consumption is reduced and heat transfer performance is increased. For lower temperatures than 40° C., the energy saving fluid provides a decrease in the cycle number of compressors with increasing the heat carrying capacity by means of the specific heat capacity. Therefore energy consumption is reduced and heat transfer performance is increased.

At about 40° C., the energy saving fluid has approximately the same specific heat capacity values with water.

At lower degrees than 40° C., the specific heat capacity value of the energy saving fluid is elevated by the decrease of temperature. At lower temperatures than 40° C., the present invention has higher specific heat capacity value than water. Thus, the invention provides an increase in the heat transfer capacity of the heat and the invention heats up slower below 40° C. compared to temperatures above 40° C. degrees with the increase in the specific heat capacity of the invention below 40° C., the present invention heats up more slowly than water and maintain lower temperatures longer than water.

The present invention is used for heating and cooling systems in different temperatures. Above 40° C., the energy saving fluid is used in heating systems and below 40° C. it is used in cooling systems for energy saving. The present invention provides reduction of energy consumption and increase in heat transfer performance for both heating and cooling systems.

In the preferred embodiment of the present invention, the input and output temperature difference of a heat transfer system is increased by the increase of temperature. In applications % 100 water used heat transfer system, the input and output temperature difference decreases with the temperature increase. Particularly, above 40° C., the temperature difference is higher than temperature difference of water and below 40° C. the temperature difference is lower than temperature difference of water (FIG. 2).

Generally in heating systems, flow rate and the transfer surface area are increased to be able to improve the heat transfer performance. In the present invention, such optimizations are not required.

The present invention is used for both heating and cooling systems for energy saving. In both systems, the present invention provides reduction in energy consumption and increase the heat transfer performance. It provides these technical advantages for cooling systems below 40° C. and for heating systems above 40° C. For heating systems, the present invention provides a reduction in fuel consumption; for cooling systems, the present invention provides a reduction in the operation duration of the compressors.

In the preferred embodiment of the present invention, in the heating system for heat transfer, operation durations of heater and pumps are decreased above 40° C. compared to systems using 100% water to maintain a steady temperature.

In the preferred embodiment of the present invention, in the cooling system, operation durations of cooler and pumps are decreased below 40° C. compared to systems using 100% water, to maintain a steady temperature.

Since the viscosity of the energy saving fluid is lower than water viscosity (1,0020 Pa·s) value, the energy consumption in pumps for both heating and cooling systems is less than that of fluids with added chemicals aiming to change freezing and boiling points.

The energy conservation in these systems using the present invention is up to 35% compared to % 100 water using systems.

Within the scope of this basic concept, it is possible to develop various embodiments of the inventive “An Energy Saving Fluid”. The invention cannot be limited to the examples described herein; it is essentially according to the claims.

1. An energy saving fluid composition consisting essentially of;
monoethylene glycol (MEG) in the overall range of 70% to 80% by volume of the fluid composition,
glycerin in the overall range of 10% to 20% by volume of the fluid composition,
triethanolamine in the overall range of 0.01% to % 3 by volume of the fluid composition,
corrosion inhibitor in the overall range of 0.01% to % 3 by volume of the fluid composition,
a pH control agent in the overall range of 0.01% to % 4 by volume of the fluid composition,

2. The composition in accordance with claim 1, wherein the composition contains propylene glycol in the overall range of 10% to 20% by volume of of the fluid composition.

3. The composition in accordance with claim 2, wherein corrosion inhibitor is selected from the group consisting of inhibitors for iron, zinc, aluminum, copper and combinations thereof.

4. The composition in accordance with claim 3, the composition is diluted with water.

5. The composition in accordance with claim 4, the composition is diluted with water to 40% to % 60 for the use in heat transfer systems.

6. The composition in accordance with claim 5, wherein the composition has a viscosity in a range of 0.015-0.025 Pa·s.

7. The composition in accordance with claim 6, wherein the composition has a freezing point about −40° C. and and boiling point about 180° C.

8. The composition in accordance with claim 7, wherein the specific heat capacity of the composition is slowly decreased by the increase of temperature.

9. The composition in accordance with claim 8, wherein specific heat capacity of the composition is lower than specific heat capacity of water above 40° C.

10. The composition in accordance with claim 8, where in specific heat capacity of the composition is higher than specific heat capacity of water below 40° C.
